(19) United States
(12) Patent Application Publication
(10) Pub. No.: US 2005/0186462 A1
(43) Pub. Date: Aug. 25, 2005

(54) PEM fuel cell stack with floating current collector plates

(76) Inventors: Raymond Belanger, Coquitlam (CA); John Jianyue Shen, Surrey (CA); Zuomin Dong, Victoria (CA); Jeremy John Tomlinson, North Vancouver (CA)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/033,033

(22) Filed: Jan. 11, 2005

Related U.S. Application Data
(60) Provisional application No. 60/535,509, filed on Jan. 12, 2004.

(51) Int. Cl. H01M 8/02; H01M 2/08

(52) U.S. Cl. 429/34; 429/35

(57) ABSTRACT

A proton exchange membrane (PEM) fuel cell end plate assembly provides an axial direction electric lead on an end plate of the assembly, and minimizes the contact resistance between an end fluid separator plate of a fuel cell stack and a current collector of the assembly. The current collector comprises an electrically conductive flat plate and a solid member connected together. The member goes through an opening on the end plate and provides an axial direction electric lead from the fuel cell stack. Means are provided to firmly contact the current collector and the fluid separator plate to maintain good contact across the entire area between the two components. The means of firmly contacting include moulding or bonding the separator plate and current collector together, or applying pressure to the separator plate and current collector such that firm contact is maintained between the two components.

### CROSS-REFERENCE TO RELATED APPLICATION

This application claims the benefit of U.S. Provisional Patent Application No. 60/535,509, filed Jan. 12, 2004.

### FIELD OF THE INVENTION

This invention relates generally to electrochemical fuel cell stacks and, more particularly, to proton-exchange-membrane (“PEM”) fuel cell stacks.

### BACKGROUND OF THE INVENTION

Electrochemical fuel cells convert fuel and an oxidant to electricity and a reaction product. In electrochemical fuel cells employing hydrogen as the fuel and oxygen or air as the oxidant, the reaction product is water. Solid polymer fuel cells generally include a membrane electrode assembly (“MEA”) layer comprising a solid polymer electrolyte or ion exchange membrane disposed between two electrode layers. The electrode layers typically comprise porous, electrically conductive sheet material and an electrocatalyst at each membrane-electrode interface to promote the desired electrochemical reaction.

At the anode, the fuel (typically hydrogen) moves through the porous electrode material and is oxidized at the anode electrocatalyst to form cations, which migrate through the membrane to the cathode. At the cathode, the oxidizing gas (typically oxygen contained in air) moves through the porous electrode material and is reduced by reaction with the cations at the cathode electrocatalyst to form the reaction product (water).

In conventional fuel cells, the MEA layer is interposed between two substantially fluid-impermeable, electrically-conductive plates, commonly referred to as separator plates. The separator plates typically serve as current conductors, provide structural support for the electrode layers, provide means for directing the fuel and oxidant to the anode and cathode layers respectively, and provide means for exhausting reaction products, such as water, formed during operation of the fuel cell. Separator plates having reactant channels are sometimes referred to as fluid flow field plates.

Preferably, the separator plates should have: excellent electrical conductivity, electrochemical stability, structure integrity, size stability, low manufacturing cost and good manufacturability. Machined, moulded or screen-printed graphite or carbon plates exhibit many of these characteristics and are thus typically used for the separator plates. Alternatively, separator plates can be made of coated regular metals or corrosion-resistant metals, depending upon the sensitivity of the fuel cell membrane and catalyst to ion contamination.

It is well known to stack fuel cells together and connect them in series to obtain a desired voltage and power output. An early example of a fuel cell stack is illustrated in Maru U.S. Pat. No. 4,444,851 granted 24 Apr. 1984; a later example is illustrated in Washington U.S. Pat. No. 5,514,487 granted 7 May 1996. A typical fuel cell stack assembly comprises: (a) means for containing the fuel cell stack; (b) means for connecting the stack to external electric devices to pass electric power; (c) means for providing fuel gas and oxidizing gas to the reactant channels and for conducting reaction product, fuel gas and oxidizing gas from the reactant channels; and (d) means for cooling the fuel cell stack.

The means for containing the fuel cell stack typically serve to compress and align the fuel cell stack. Compression serves to press the individual fuel cell components and the fuel cells together in order to prevent leaks from the seals and to provide good electrical contact between the components. Proper alignment of the components aids in preventing leaks from the seals, particularly in the case of fuel cell stacks having internal manifolds. In use, the length of the fuel cell stack tends to fluctuate due to: temperature changes (the fuel cell stack generates heat and expands during operation, and cools and contracts after use) and water absorption and resulting hydro-expansion of the proton exchange membrane of the MEA layer to support the electrochemical reactions. Typically. the means for containing the fuel cell stack include means for compensating for this size fluctuation, such as springs.

Various means for containing fuel cell stacks are known. One known means is a “rods and plates” type fuel cell stack assembly and exemplified by U.S. Pat. No. 5,419,980 (Okamoto et al.); such an assembly comprises two end plates between which fuel cells are sandwiched. Referring to FIG. 1 (Prior art), the assembly comprises several key components, including fluid flow field plates and MEA 103, tension rods 100, end plates 101, current collectors 102, and compression springs (not shown) that are added between one end plate 101 of the stack and nuts 104 of the rods 100. The end plates 101 are typically larger than the fuel cells 103 and have holes spaced about their peripheries. Rods 100 having threaded ends are inserted in the holes so as to run through a hole in each end plate 101. Nuts 104, threaded onto each end of the rods 100 and tightened down, provide a compressive force. Coil springs and washers (not shown), placed between the nuts 104 and one of the end plates 101, permit the end plate 101 to move perpendicularly to the rods to compensate for expansion and contraction of the fuel cells 103. The current collectors 102 are metallic plates, placed at both ends of the bipolar plate stack, and serve to collect and pass electric power generated by the fuel cells 103 to external devices. The current collectors 102 are in direct contact with the first and last bipolar separator plates 103 in the stack, and electrically connect all serially stacked fuel cells 103 to external electric appliances. The current collectors 102 also merge the electric current generated across the entire active area of the fuel cells 103 into an electric lead or wire connector (not shown) to pass electric current to external electric appliances.

The current collectors in most PEM fuel cell stack designs serve as edge current collectors, by which electric current is collected from the entire active area of the first and last fuel cells in the stack, and passed to two power cords attached to the edge of each of the two current collectors at both ends of the stack. Alternatively, some PEM fuel cell architecture insulates the rods and the end plates and uses the two end plates as current collectors. Both designs have noticeable drawbacks for practical industrial applications. The edge current collector design has inconvenient and intruding wire connectors on one side of the stack. The end plate current collector design has inconvenient and electrically “hot” end plates.

### SUMMARY OF THE INVENTION

The contact resistance between bipolar plates and current collectors is relatively high, compared to the resistance of the two materials, due to the electro-potential differences between dissimilar materials. This contact resistance is very sensitive to the contact pressure that determines the effective area of contact. It is desirable to maintain perfect contact at every point between the bipolar separator plate and the current collector. It is therefore an object of the invention to provide a fuel cell stack having improved contact between the separator plate and the current collector. Another objective of this invention is to isolate the current collectors from,any gases or cooling medium used in the stack during operation.

According to one aspect of the invention, there is provided an end plate assembly for a proton exchange membrane fuel cell stack that comprises: an end plate having means for physically coupling the end plate to another end plate such that pressure is applied to a fuel cell stack sandwiched between the end plates, and a current collector opening therethrough; a current collector comprising an electrically conductive plate having a front side for contacting an electrically conductive separator plate and an electrically conductive member extending from a backside of the current collector plate and through the current collector opening in the end plate, such that the member can be electrically coupled to an external electrical connector; and means for maintaining even contact between the current collector and separator plate to minimize electrical contact resistance therebetween.

The means for maintaining even contact can be a flexible pad mounted between the end plate and current collector plate such that pressure from the end plate is distributed by the pad to the current collector and separator plate. Alternatively, the means for maintaining even contact can be a separator plate adhesively bonded or moulded to the current collector plate such that the front side of the current collector plate evenly contacts an electrically conductive portion of the separator plate.

The end plate assembly can further comprise an electrical insulator mounted between the end plate and the flexible pad or current collector. This insulator serves to electrically insulate the end plate from the rest of the fuel cell stack. This electrical insulator can be a plate having a front side with a cavity configured to receive the flexible pad and current collector plate, and a current collector opening through the electrical insulator plate for receiving the current collector member. The electrical insulator can further comprise at least one gas manifold through the electrical insulator plate and flexible seals for fluidly sealing the insulator to the separator plate. The stiffness of the flexible pad can be selected to ensure that fluid seals are maintained between separator plate and insulator. In particular, the flexible pad can be selected from the group consisting of a polymer mat, a spring, and a Bellevue washer.

For a current collector that is bonded or moulded to the separator plate and that lacks a flexible pad, the electrical insulator can be mounted between the end plate and the current collector, to electrically insulate the end plate from the rest of the fuel cell stack. In such case, the electrical insulator can be a plate having a front side with a cavity configured to receive the current collector plate, and a current collector opening through the electrical insulator plate for receiving the current collector member.

According to another aspect of the invention, there is provided an end plate assembly for a proton exchange membrane fuel cell stack, comprising: an end plate having means for physically coupling the end plate to another end plate such that pressure is applied to a fuel cell stack sandwiched between the end plates; a current collector comprising an electrically conductive plate having a front side for contacting an electrically conductive separator plate of a fuel cell; and a flexible pad mounted between the end plate and current collector such that pressure from the end plate is distributed by the pad to the current collector and separator plate thereby minimizing electrical contact resistance therebetween.

### BRIEF DESCRIPTION OF THE DRAWINGS

FIG. 1 is a schematic isometric view of a prior art fuel cell stack.

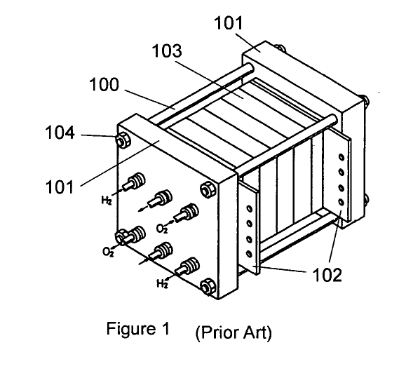

FIG. 2 is a schematic isometric view of a PEM fuel cell stack with a pair of end plate assemblies compressing fuel cells with tension rods.

FIG. 3 is a schematic exploded isometric view of one of the end-plate assemblies of FIG. 2.

FIG. 4 is a schematic isometric view of a current collector of the end plate assembly contacting a fuel cell fluid flow field plate of a fuel cell.

FIG. 5 is a schematic side cut-away view of components of the end plate assembly through a first plane (“vertical plane”).

FIG. 6 is a schematic side cut-away view of components of the end plate assembly through a second plane perpendicular to the first plane (“horizontal plane”).

### DETAILED DESCRIPTION OF EMBODIMENTS OF THE INVENTION

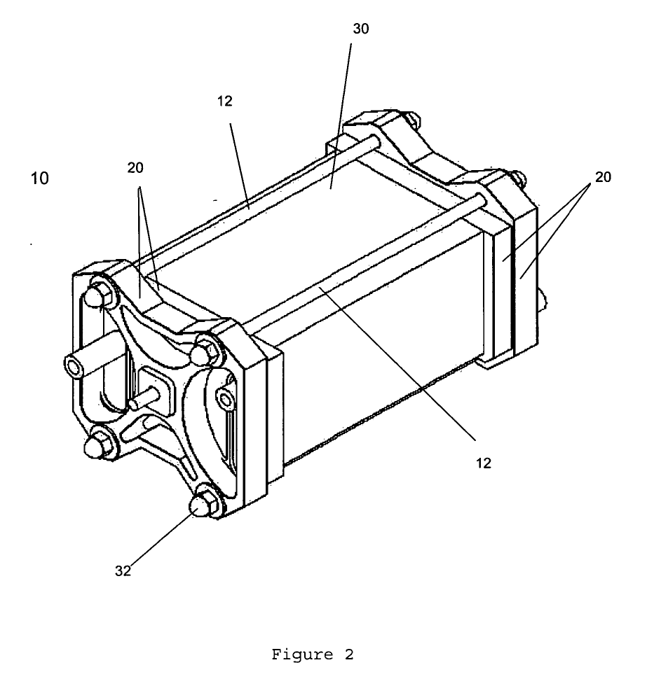

Referring to FIG. 2 and according to one embodiment of the invention, a fuel cell stack assembly 10 comprises a pair of fuel cell end plate assemblies 20 sandwiching multiple fuel cells 30 (shown as a single block in FIG. 2). Tie rods 12 are fastened at each end to an end plate assembly 20 by spring-loaded tie rod nuts 32, thereby physically connecting the end plate assemblies 20 together; a selected pressure can be applied to the fuel cells 30 by selective adjustment of the tie rod nuts 32.

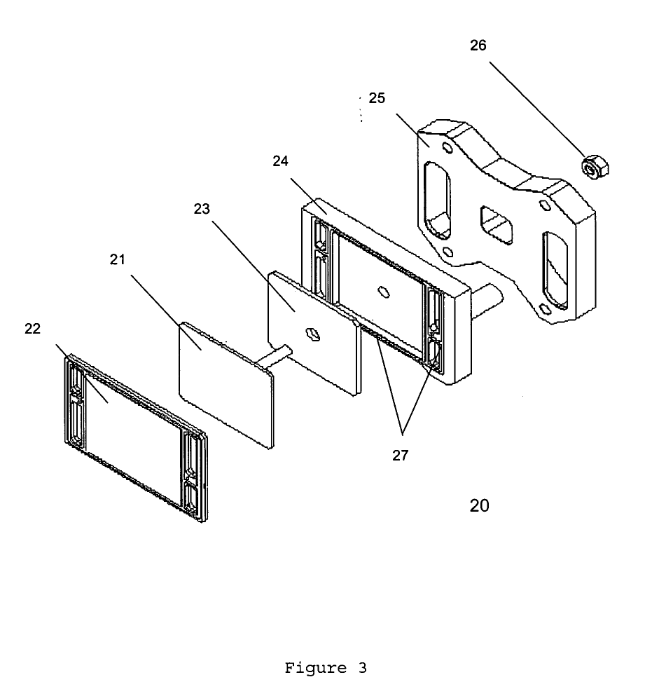

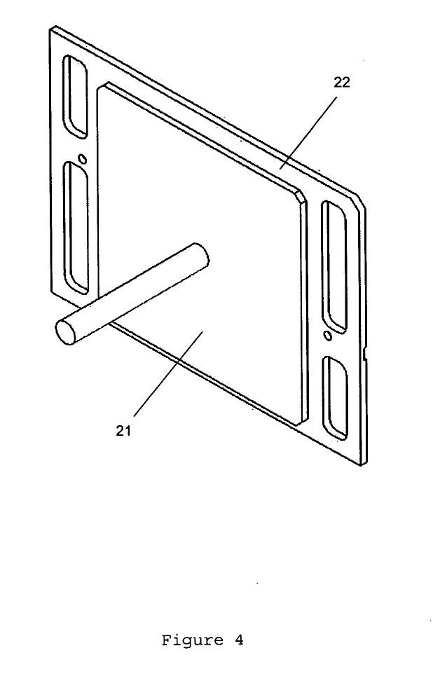

Referring to FIG. 3, each end plate assembly 20 comprises a current collector 21; an elastic pad 23; a current and gas insulator 24; an end plate 25; a current collector retention nut 26, and seals 27. The components 21, 23, 24, 25, 26, and 27 of the end plate assembly 20 cooperate in such a way that minimizes the electrical contact resistance between an end (first or last) fluid flow field plate 22 of the fuel cell stack 10 and the current collector 21. This is accomplished by arranging the current collector 21 and the end fluid flow field plate 22 such that substantially even contact is maintained across the entire contact area between the two components 21, 22, as shown in FIG. 4. While the current collector 21 is shown contacting a fluid flow plate 22, it is within the scope of invention for the current collector 21 to contact any type of conductive separator plate of the fuel cell.

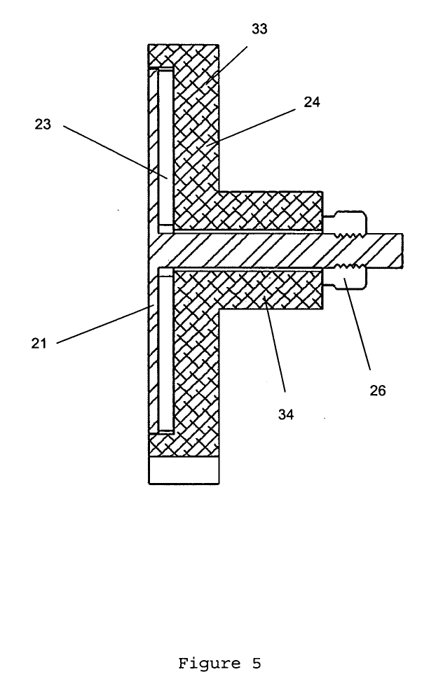

The end plates 25 in the end plate assemblies 20 cooperate with the tie rods 12 to apply pressure to the fluid flow field plate 22 and current collector 21. Referring particularly to FIGS. 3 and 5, the current collector 21 comprises a transverse flat plate and an axial solid member that is attached at one end to a central portion on a backside of the plate. The member extends through an opening in the elastic pad 23, such that when assembled, the pad 23 rests against the back side of the current collector plate.

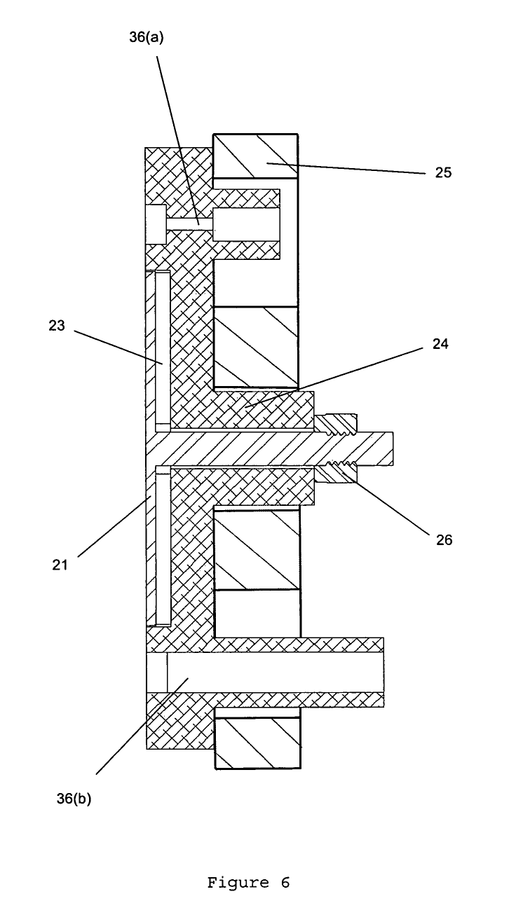

The current and gas insulator 24 comprises a transverse plate 33 with a front surface and a back surface. A rectangular cavity is recessed in the front surface, and a central tube 34 extends from the central part of the back surface. A bore extends through the central tube 34 and the transverse plate 33, and is dimensioned to accept the current collector member. When the member is threaded through the current and gas insulator 24, the elastic pad 23 and current collector 21 fit within the cavity. Referring to FIGS. 3 and 6, the insulator 24 has a plurality of gas manifolds extending through the plate 33 and located around the periphery of cavity, including a fuel supply manifold 36(a), an oxidant supply manifold 36(b), as well as fuel and oxidant exhaust manifolds (not shown in FIG. 6 but visible in FIG. 3). The gas manifolds of the insulator 24 align with internal gas manifolds of the fuel cell separator plates 22 when the fuel cell stack 10 is assembled, and enable gas to be fed to and exhausted from the fuel cells 30. The insulator 24 can also be made of a gas impermeable, chemically stable, electrically non-conductive material such as plastic, nylon or fibreglass, to enable it to flow gas through the gas manifolds 36(a), (b) and electrically insulate the end plate 25 from the rest of the fuel cells 30, thus allowing the end plate 25 and tension rods 12 to be made of an electrically conductive metal, if desired. The seals 27 around the cavity of the insulator plate 33 fluidly isolate the current collect plate 21 from the gas manifolds 36(a), (b), as well as fluidly couples the gas manifolds 36(a), (b) to the counterpart gas manifolds of the separator (or fluid flow field) plate 22. Compression of insulator 24 against the end plate 25 is sufficient to establish a fluid seal between the gas manifolds of the two components 24 and 25.

The current collector 20, elastic pad 23, and insulator 24 collectively form a compression subassembly. The end plate 25 has a current collector opening through the centre of the plate 25 for receiving the current collector member and insulator tube 34, tie member openings through the edges of the plate 25 for receiving tie rods 12 therethrough, and elongate manifolds also through the edges of the plate that align with the gas manifolds of the insulator 24 when the fuel cell stack 10 is assembled.

The current collector member extends through the current collector opening in the compression end plate 25 and is secured in place with the retention nut 26, which is screwed onto threads (not shown) at the end of the member. The member and nut 26 serve as an axially extending electric lead from the fuel cell stack 10 for coupling to an external electrical connection. This design avoids the problems associated with a fuel cell stack having transversely extending leads, such as interference by transversely protruding leads when stacking multiple fuel cell stacks together side-by-side. This design also avoids the problems associated with using the entire end plate 25 as an electrically conductive lead; the insulator tube surrounding the current collector member prevents the end plate 25 from becoming electrically “hot”.

The elastic pad 23 is thicker than the depth of its holding cavity on the current and gas insulator 24 to ensure best contact between the fluid flow field plate 22 and the current collecting plate 21 under stack compression. The stiffness of the elastic pad 23 is selected to ensure functional sealing between the fluid flow field plate 22 and the insulator 24 under stack compression. Suitable materials for the elastic pad 23 include polymer mats of different Shore harnesses, springs, Belleville washers. Such materials should be softer than the seals used between the fluid flow field plate 22 and the current and gas insulator 24 to avoid seal leaks and to ensure that the local compression between the current collector 21 and the flow field plate 22 is not interfering with the global compression of the entire fuel cell stack. Also, preferably, the elastic pad 23 should have good and constant compression characteristics within the expected operating temperature range of the fuel cell assembly 10.

After the current collector 21, elastic pad 23, current and gas insulator 24, and current collecting plate retention nut 26 are assembled, the current collector 21 will stick out of the cavity on the current and gas insulator 24 so that it can firmly contact the flow field plate 22. When the stack 10 is assembled and the tie rod nuts 32 are tightened, a compression force is applied to the end plate assemblies 20 which deforms the elastic pad 23 and pushes the current collector 21 back into the cavity. The local compression from the forced deformation of the elastic pad 23 ensures that the entire current collector 21 and fluid flow field plate 22 remain in very good contact. In essence, the current collector 21 “floats” against the elastic pad 23 and is movable relative to the rest of the end plate assembly 20. This design enables the fuel cell assembly 10 to be relatively tolerant to manufacturing imperfections; for example, even pressure can still be maintained between the current collector 21 and the flow field plate 22 even if one or more components were not perfectly machined flat or two or more components were not in perfect alignment.

According to another embodiment of the invention, contact can be established between the flow field plate 22 and current collector 21 by moulding or bonding the two components 21, 22 together such that solid contact is maintained between the two components 21, 22. When bonding, the selection of the bonding agent needs to consider the electro-potentials of the flow field plate and current collector materials to minimize the “contact” resistance therebetween. Suitable bonding agents include a graphite-loaded, epoxy-based conductive glue, although other known suitable bonding agents known in the art can also be used. Alternatively, the current collecting plate 21 can be made of metal or another excellent conducting material, and the fluid flow field plate 22 can be moulded from carbon or graphite composite material onto the current collector plate 21 such that the two components 21, 22 are permanently joined and solid contact is established across the active areas of the two components 21, 22. Since solid contact is maintained between the flow field plate 22 and current collector 21 by the bonding or moulding, no elastic pad 23 or retention nut 26 is required to apply pressure.

While the present invention has been described herein by the preferred embodiments, it will be understood to those skilled in the art that various changes may be made and added to the invention. The changes and alternatives are considered within the spirit and scope of the present invention.

1. An end plate assembly for a proton exchange membrane fuel cell stack, comprising:
a) an end plate having means for physically coupling the end plate to another end plate such that pressure is applied to a fuel cell stack sandwiched between the end plates, and a current collector opening therethrough;
b) a current collector comprising an electrically conductive plate having a front side for contacting an electrically conductive separator plate and an electrically conductive member extending from a backside of the current collector plate and through the current collector opening in the end plate, such that the member can be electrically coupled to an external electrical connector; and
c) means for maintaining even contact between the current collector and separator plate to minimize electrical contact resistance therebetween.

2. An end plate assembly as claimed in claim 1 wherein the means for maintaining even contact is a flexible pad mounted between the end plate and current collector plate such that pressure from the end plate is distributed by the pad to the current collector and separator plate.

3. An end plate assembly as claimed in claim 1 wherein the means for maintaining even contact is a separator plate adhesively bonded to the current collector plate such that the front side of the current collector plate evenly contacts an electrically conductive portion of the separator plate.

4. An end plate assembly as claimed in claim 1 wherein the means for maintaining even contact is a separator plate moulded onto the current collector plate such that the front side of the current collector plate evenly contacts an electrically conductive portion of the separator plate.

5. An end plate assembly as claimed in claim 2 further comprising an electrical insulator mounted between the end plate and the flexible pad or current collector and electrically insulating the end plate from the rest of the fuel cell stack.

6. An end plate assembly as claimed in claim 5 wherein the electrical insulator is a plate having a front side with a cavity configured to receive the flexible pad and current collector plate, and a current collector opening through the electrical insulator plate for receiving the current collector member.

7. An end plate assembly as claimed in claim 3 further comprising an electrical insulator mounted between the end plate and the current collector, and electrically insulating the end plate from the rest of the fuel cell stack.

8. An end plate assembly as claimed in claim 7 wherein the electrical insulator is a plate having a front side with a cavity configured to receive the current collector plate, and a current collector opening through the electrical insulator plate for receiving the current collector member.

9. An end plate assembly as claimed in claim 4 further comprising an electrical insulator mounted between the end plate and the current collector, and electrically insulating the end plate from the rest of the fuel cell stack.

10. An end plate assembly as claimed in claim 9 wherein the electrical insulator is a plate having a front side with a cavity configured to receive the current collector plate, and a current collector opening through the electrical insulator plate for receiving the current collector member.

11. An end plate assembly as claimed in claim 6 wherein the electrical insulator further comprises at least one gas manifold through the electrical insulator plate and flexible seals for fluidly sealing the insulator to the separator plate.

12. An end plate assembly as claimed in claim 8 wherein the electrical insulator further comprises at least one gas manifold through the electrical insulator plate and flexible seals for fluidly sealing the insulator to the separator plate.

13. An end plate assembly as claimed in claim 10 wherein the electrical insulator further comprises at least one gas manifold through the electrical insulator plate and flexible seals for fluidly sealing the insulator to the separator plate.

14. An end plate assembly as claimed in claim 1 1 wherein the stiffness of the flexible pad is selected to ensure the fluid seals are maintained between separator plate and insulator.

15. An end plate assembly as claimed in clam 14 wherein the flexible pad is selected from the group consisting of a polymer mat, a spring, and a Bellevue washer.

16. An end plate assembly for a proton exchange membrane fuel cell stack, comprising:
a) an end plate having means for physically coupling the end plate to another end plate such that pressure is applied to a fuel cell stack sandwiched between the end plates;
b) a current collector comprising an electrically conductive plate having a front side for contacting an electrically conductive separator plate of a fuel cell; and
c) a flexible pad mounted between the end plate and current collector such that pressure from the end plate is distributed by the pad to the current collector and separator plate thereby minimizing electrical contact resistance therebetween.
